(19) United States
(12) Patent Application Publication
(10) Pub. No.: US 2005/0131991 A1
(43) Pub. Date: Jun. 16, 2005

(54) Network apparatus and program product

(75) Inventors: Kazuya Ogawa, Mizuho-city (JP); Ken Yamada, Kusatsu-city (JP); Toshiyuki Hirata, Otsu-city (JP); Yoshinori Hatayama, Komaki City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/008,191

(22) Filed: Dec. 10, 2004

(30) Foreign Application Priority Data
Dec. 10, 2003 (JP) 2003-412624 (P)

(51) Int. Cl. G06F 15/16

(52) U.S. Cl. 709/201

(57) ABSTRACT

When an appliance is connected to the home network, appliance information is transmitted to a display terminal from the appliance. The display terminal transmits the received appliance information to a management server and requests the management server to transmit appliance icon information of the appliance. The management server extracts icon information conforming to the received appliance information from an icon database and sends the icon information to the display terminal. The display terminal generates an appliance icon image from the acquired icon information and superimposes and displays the appliance icon image on a floor plan image of a house. When a user moves the appliance icon to an installation location on a display screen, a room No. of a moving destination and an installation position in the room are detected. The detected positional information is sent to the management server and registered in association with the appliance.

### BACKGROUND OF THE INVENTION

1. Field of the Invention

The present invention relates to a network apparatus and a program product, and more particularly to a network apparatus and a program product preferably used in registering positional information of an appliance connected to a network.

2. Description of the Related Art

In recent years, a so-called home networking system for controlling home appliances via a home network has been proposed and standardized. In this system, a controller such as a home server is connected to a home network. This controller transmits a control command to control an object apparatus.

Here, communication between the controller and the home appliances is performed using a communication protocol such as ECHONET, UPnP, or SCP. A power supply line or the like for supplying power to the respective home appliances is used as a communication network. In other words, the home appliances and the controller are connected to the home network by connecting sockets of the home appliances and the controller to a power supply terminal.

As an example of a structure of such a network system, a network system described in JP 2003-52093 A is known. In this system, plan information of floors of a house, positional information of home appliances, and icon information of the respective appliances are stored in a controller. The appliance icons are superimposed and displayed on the plan, whereby complicated function setting and appliance control can be realized by intuitive operations.

When a new appliance is connected to a home network system, it is necessary to cause a controller to hold positional information indicating an installation position for the appliance. However, in the present network system, a user sets an installation location in the controller by manual input while actually confirming the installation location of the appliance. Note that JP 2003-2093 A describes no input method for the positional information. In this case, again, it is assumed that complicated work such as manual input in setting the positional information is required.

### SUMMARY OF THE INVENTION

It is an object of the present invention to provide a network apparatus and a program product with which a user can set positional information intuitively by simple work in connecting appliances to a network system.

A first aspect of the present invention is grasped as a network apparatus connected to a home network.

In order to acquire information on an installation position of an appliance connected to a home network, the network apparatus includes: room image display means that displays a room constitution in a building as a room image; appliance icon display means that generates an icon image corresponding to the appliance connected to the home network and superimposes and displays the icon image on the room image; appliance icon moving means that moves the appliance icon on a display screen; and position detection means that detects the installation position of the appliance in the building based on a position of the appliance icon after the movement.

In the network apparatus, the room image display means may divide a floor plan image, in which rooms in the building are arranged as a floor plan, for each floor of the building and display the floor plan image.

Further, the appliance icon display means may acquire corresponding icon image information based on appliance information acquired from an appliance connected to the home network. The appliance icon display means includes, for example, an appliance icon database storing icon image information in association with a predetermined appliance section and extracts icon image information, which corresponds to the appliance information acquired from the appliance connected to the home network, from the appliance icon database.

Alternatively, the appliance icon display means accesses a server provided with an appliance icon database storing icon image information in association with a predetermined appliance section to provide the server with the appliance information acquired from the appliance connected to the home network and request the server to transmit corresponding icon image information.

Further, the position detection means may detect a room to which the appliance icon moves and a position of the appliance icon in the room and acquire identification information of the room and information on the position of the appliance icon in the room as installation position information of the appliance.

A second aspect of the present invention is grasped as a program product that gives a computer a function for acquiring information on an installation position of an appliance connected to a home network. The function given by the program product includes room image display processing for displaying a room constitution in a building as a room image; appliance icon display processing for generating an icon image corresponding to the appliance connected to the home network and superimposing and displaying the icon image on the room image; appliance icon moving processing for moving the appliance icon on a display screen; and position detection processing for detecting an installation position of the appliance in the building based on a position of the appliance icon after the movement.

In the program product, the room image display processing may include processing for dividing a floor plan image, in which rooms in the building are arranged as a floor plan, for each floor of the building and displaying the image.

Further, the appliance icon display processing may include processing for acquiring corresponding icon image information based on appliance information acquired from the appliance connected to the home network. For example, an appliance icon database storing icon image information in association with a predetermined appliance section is included in the program product. The appliance icon display processing includes processing for extracting icon image information, which corresponds to the appliance information acquired from the appliance connected to the home network, from the appliance icon database. Alternatively, the appliance icon display processing may include processing for accessing a server provided with an appliance icon database in which icon image information is stored in association with a predetermined appliance section and acquiring the appliance information corresponding to the appliance connected to the home network from the server.

Further, the position detection processing may include processing for detecting a room to which the appliance icon is moved and a position of the appliance icon in the room and acquiring identification information of the room and information on an appliance icon position in the room as installation position information of the appliance.

### BRIEF DESCRIPTION OF THE DRAWINGS

The above-mentioned and other objects and new characteristics of the present invention will be apparent more entirely when explanations of embodiments indicated below are read in conjunction with the accompanying drawings, in which:

FIG. 1 shows a structure of a home network system according to an embodiment mode of the present invention;

FIG. 2 shows a structure of a management server 100 according to a first embodiment of the present invention;

FIG. 3A shows contents of a model registration DB according to the first embodiment of the present invention;

FIG. 3B shows contents of an icon-by-model DB according to the first embodiment of the present invention;

FIG. 4A shows contents of house data according to the first embodiment of the present invention;

FIG. 4B shows contents of floor plan data according to the first embodiment of the present invention;

FIG. 4C shows contents of room parts DB according to the first embodiment of the present invention;

FIG. 5 shows an example of display of a floor plan image according to the first embodiment of the present invention;

FIG. 6 shows a structure of a display terminal 200 according to the first embodiment of the present invention;

FIG. 7 shows a flow chart of positional information registration processing according to the first embodiment of the present invention;

FIG. 8 is a diagram explaining installation processing for a new appliance according to the first embodiment of the present invention;

FIG. 9 is a diagram explaining installation processing for a new appliance according to the first embodiment of the present invention;

FIG. 10 is a diagram explaining installation processing for a new appliance according to the first embodiment of the present invention;

FIG. 11 shows a structure of a display terminal 200 according to a second embodiment of the present invention;

FIG. 12 shows contents of an icon-by-model DB according to the second embodiment of the present invention;

FIG. 13 shows a flowchart of positional information registration processing according to the second embodiment of the present invention;

FIG. 14 shows a structure of a management server 100 according to a third embodiment of the present invention;

FIG. 15A shows contents of an appliance registration DB according to the third embodiment of the present invention;

FIG. 15B shows contents of an icon-by-model DB according to the third embodiment of the present invention;

FIG. 15C shows contents of floor plan data according to the third embodiment of the present invention;

FIG. 16 shows an example of display of a room constitution image according to the third embodiment of the present invention;

FIG. 17 shows a modification of a flowchart for positional information registration processing of the present invention;

FIG. 18 shows a modification of installation processing for a new appliance of the present invention;

FIG. 19 shows a modification of positional information registration processing according to the embodiment mode of the present invention; and

FIG. 20 is a modification of the positional information registration processing according to the embodiment mode of the present invention.

### DETAILED DESCRIPTION OF THE PREFERRED EMBODIMENT

An embodiment mode of the present invention will be hereinafter explained with reference to the drawings. However, the embodiment mode to be explained below is only an example of the present invention and does not limit the scope of the present invention.

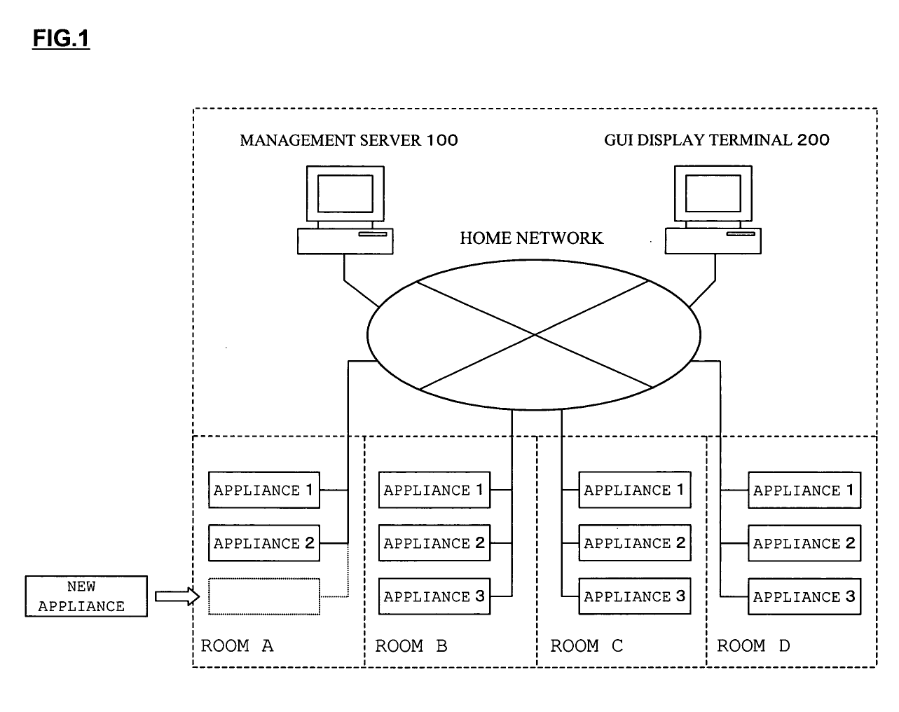

FIG. 1 shows a structure of a home network system according to the embodiment mode.

A network system of the embodiment mode includes a management server 100 and a display terminal 200. The management server 100 and the display terminal 200 have a transmission and reception function corresponding to a communication protocol such as ECHONET, UPnP, or SCP and are made connectable to appliances such as an air conditioner and a DVD via a home network such as a power supply line.

The management server 100 generates a control command according to a control instruction and transmits the control command to an appliance of a control object via the home network. The display terminal 200 displays plans of respective floors and a state of installation of appliances in rooms. When a new appliance is connected, the display terminal 200 presents a display screen for setting positional information of the appliance.

<First Embodiment>

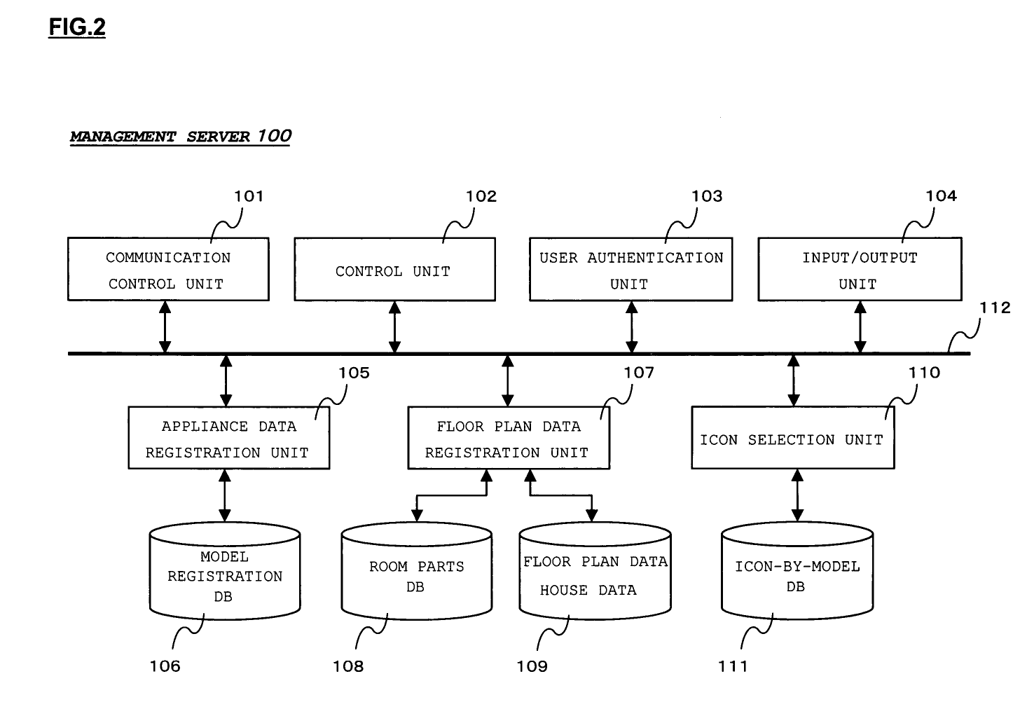

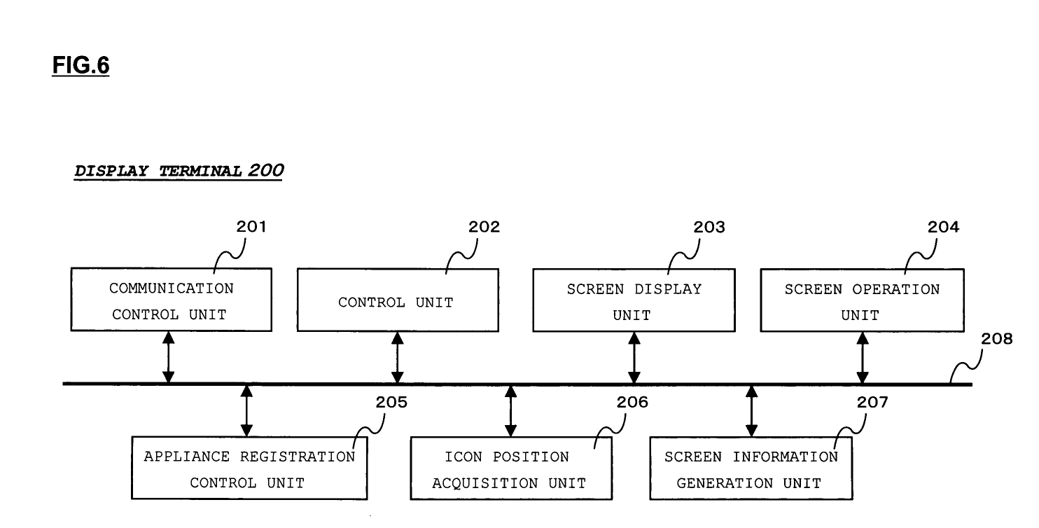

FIGS. 2 and 6 show examples of structures of the management server 100 and the display terminal 200.

The management server 100 and the display terminal 200 can be realized by a CPU, a memory, other LSIs, and the like of an arbitrary computer in terms of hardware. In addition, the management server 100 and the display terminal 200 can be realized by a program and the like having a recording control function loaded to the memory in terms of software. FIGS. 2 and 6 show functional blocks of the management server 100 and the display terminal 200 that are realized by hardware and software. However, it is needless to mention that these functional blocks can be realized in various forms such as hardware only, software only, or a combination of the hardware and the software.

Referring to FIG. 2, the management server 100 includes a communication control unit 101, a control unit 102, a user authentication unit 103, an input/output unit 104, a model data registration unit 105, a model registration database (DB) 106, a floor plan data registration unit 107, a room parts database (DB) 108, a floor plan data storage unit 109, an icon selection unit 110, an icon-by-model database (DB) 111, and a data bus 112.

The communication control unit 101 controls data exchange via the home network. The control unit 102 controls the respective units in accordance with programs. The user authentication unit 103 performs user authentication with reference to user information (a user ID and a password) registered in the inside thereof. The input/output unit 104 is used for inputting information from the outside and presenting information to the outside.

When information on a newly connected appliance is supplied via the communication control unit 101, the model data registration unit 105 registers the information in the model registration DB 106. The model registration DB 106 stores information on appliances connected to the home network. Note that a constitution of information to be stored will be described later.

The floor plan data registration unit 107 causes the floor plan data storage unit 109 to store floor plan data and house data of the user. In addition, when a request is received from the display terminal 200 via the communication control unit 101, the floor plan data registration unit 107 reads out the floor plan data and the house data from the floor plan data storage unit 109, reads out necessary room parts data from the room parts DB 108, and transmits these data to the display terminal 200 via the communication control unit 101.

The room parts DB 108 stores a parts information group concerning rooms. Details of the parts information group will be described later. The floor plan data storage unit 109 stores the floor plan data and the house data of the user. Details of the floor plan data and the house data will be described later.

When a request for provision of icon information concerning a newly connected appliance is received from the display terminal 200 via the communication control unit 101, the icon selection unit 110 selects corresponding icon information from the icon-by-model DB 111 and transmits the icon information to the display terminal 200 via the communication control unit 101. More specifically, the icon selection unit 110 refers to information on a manufacturer name, a model, and a classification of the newly connected appliance received from the display terminal 200, extracts icon information conforming to the information from the icon-by-model DB 111, and transfers the icon information to the communication control unit 101.

The icon-by-model DB 111 stores an icon information group sectioned for each appliance. Details of the icon information group will be described later.

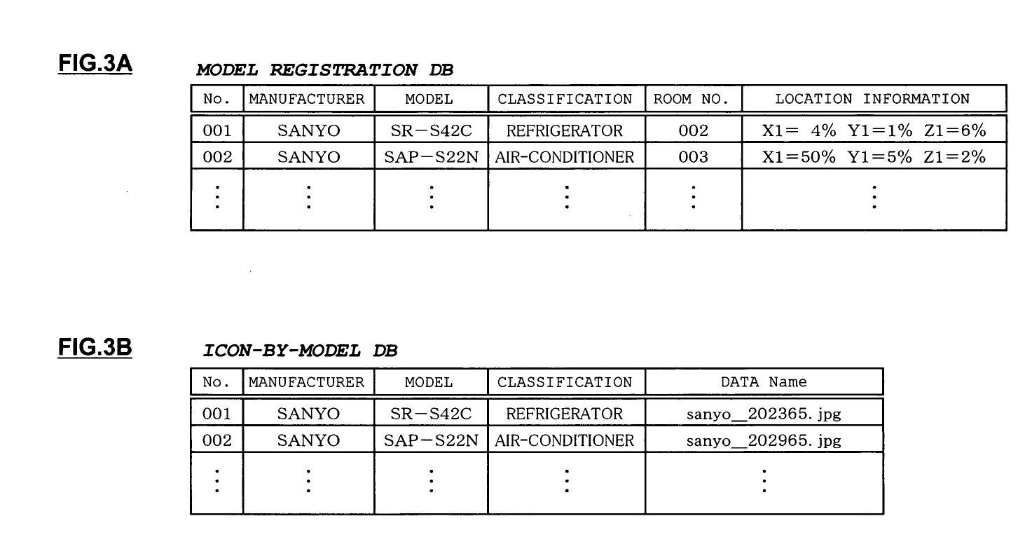

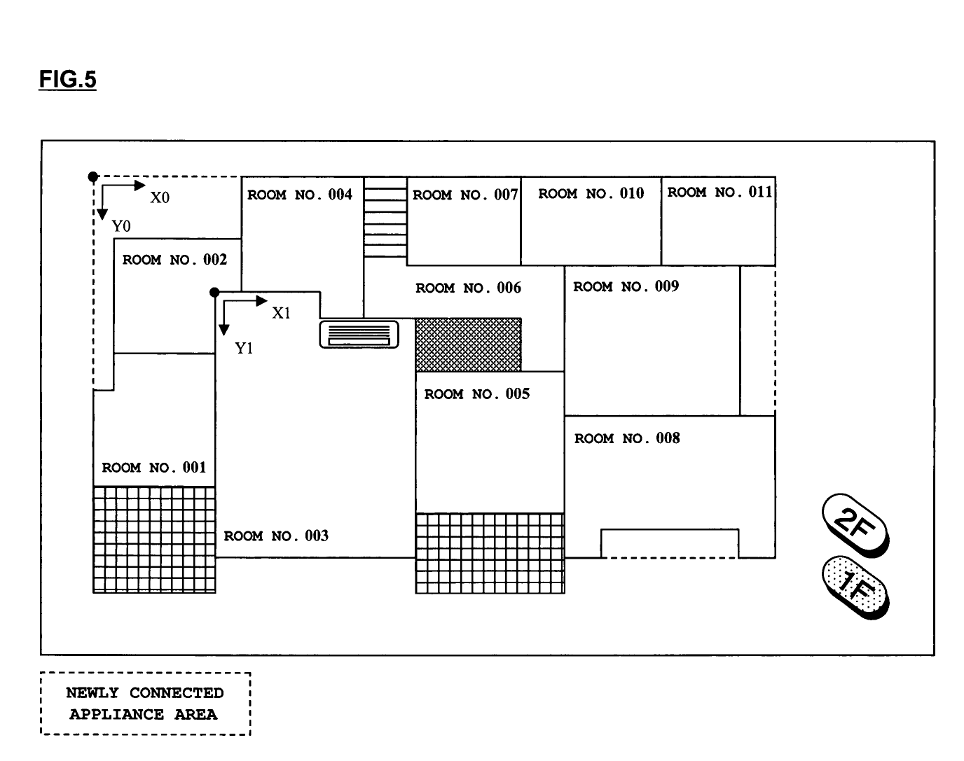

FIG. 3A shows a constitution of information stored in the model registration DB 106. As shown in the figure, a manufacturer name, a model, a classification, a room No., and location information sectioned for each appliance are stored in the model registration DB 106 as information on an appliance connected to the home network. Here, the location information is information on an installation location of the appliance and defined as a position (X1, Y1, Z1) from a reference point of a room in which the appliance is installed. More specifically, referring to FIG. 5, when a newly connected appliance is installed in a room No. 003, a position in a right direction (X1) and a position in a bottom direction (Y1) from a reference point of the room (in the figure, a black circle at an upper left corner of the room) and a position in a bottom direction (Z1) from a ceiling of the room are stored as location information.

Note that the position (X1, Y1, Z1) is represented by ratios of dimensions n the horizontal direction (X1 direction), the vertical direction (Y1 direction), and the height direction (Z1 direction) from the reference point to an appliance installation position with respect to dimensions in the horizontal direction (X1 direction), the vertical direction (Y1 direction), and the height direction (Z1 direction) of the room.

FIG. 3B shows a constitution of information stored in the icon-by-model DB 111. As shown in the figure, table information including a manufacturer name, a model, a classification, and a Data Name of icon image information and an icon image information (contents) corresponding to the Data Name are stored in the icon-by-model DB 111 as icon information. Note that the management server 100 accesses a server of each manufacturer and acquires the icon information periodically, whereby such icon information is updated. Alternatively, when a new appliance is connected to the home network, in the case in which icon information corresponding to the new appliance is not stored in the icon-by-model DB 111, the management server 100 inquires of a server on a manufacturer side about the icon information and acquires the icon information, whereby the icon information is updated.

In the case in which the corresponding icon information is not stored in the icon-by-model DB 111, the icon selection unit 110 may select icon information closest to the appliance and provide the icon information to the display terminal 200 side. For example, when only a model among a manufacturer name, a model, and a classification of the appliance is not consistent with icon information in the icon-by-model DB 111, the icon selection unit 110 only has to select icon information with which the manufacturer name and the classification are consistent. When the manufacturer name and the model are not consistent with the icon information, the icon selection unit 110 only has to select appropriate icon information (e.g., icon information having a top order) out of pieces of information with which the classification is consistent.

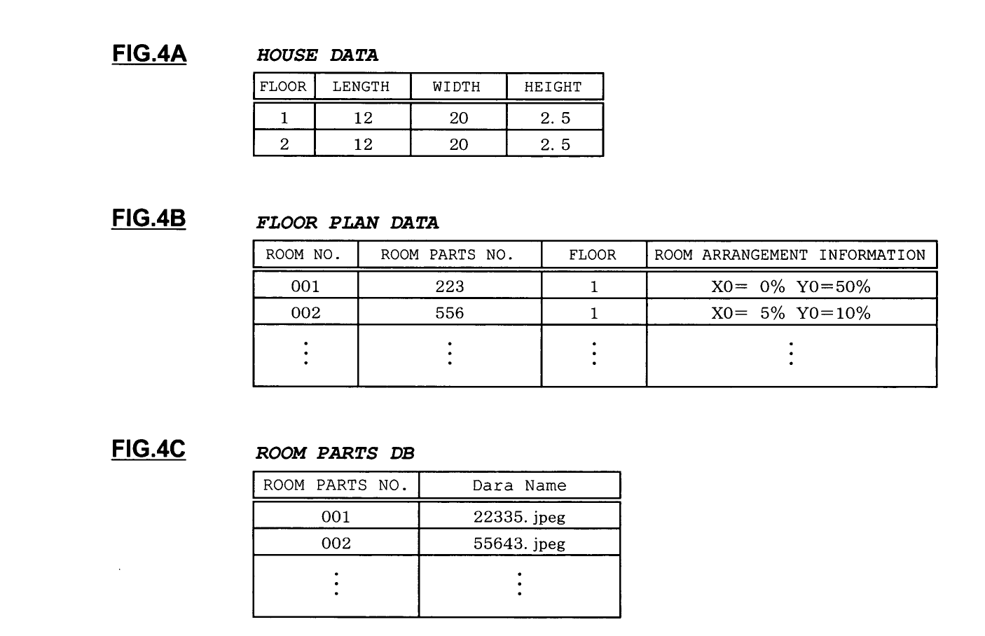

FIGS. 4A and 4B show a constitution of information (house data and floor plan data) stored in the floor plan data storage unit 109. First, referring to FIG. 4A, the house data is constituted by a depth, a width, and a height (unit: meter) of each floor. Here, for example, a rectangular area is set for each floor, and dimensions of the depth and the width are defined as a vertical dimension and a horizontal dimension of this rectangular area. For example, referring to FIG. 5, concerning a first floor of this building (house), a rectangular area (indicated by a dotted line in the figure) defining an outer periphery of the first floor is set, and a dimension in a horizontal direction (X0 direction) and a dimension in a vertical direction (Y0 direction) of this rectangular area are adopted as a depth and a width of house data, respectively.

Next, referring to FIG. 4B, the floor plan data is constituted by a room No., a room parts No., information indicating which floor of the house the floor plan is related to, and information indicating which position on this floor the room is arranged (room arrangement information).

Here, the room parts No. specifies which parts constitute the room among a room parts group (described later) stored in the room parts DB 108. In other words, each room has a shape and an area specified by the room parts No.

In addition, the room arrangement information defines in which position each room is located on a rectangular area of each floor defined by the house data. Here, a position (X0, Y0) is defined as ratios of a horizontal dimension and a vertical dimension from a reference point to the room position with respect to a horizontal dimension and a vertical dimension of the rectangular area. For example, referring to FIG. 5, in the case in which a reference point is set at an upper left corner (black circle) of the rectangular area, the reference point of the room is placed in a position where a ratio in the horizontal direction is X0 and a ratio in the vertical direction is Y0 from this reference point.

FIG. 4C shows a constitution of information stored in the room parts DB 108. As shown in the figure, table information consisting of a room parts No. and a Data Name of room parts information defined by the room parts No. and a contents (image information, boundary information, etc.) of room parts information corresponding to each Data Name are stored in the room parts DB 108.

Next, the display terminal 200 will be explained with reference to FIG. 6.

As shown in the figure, the display terminal 200 includes a communication control unit 201, a control unit 202, a screen display unit 203, a screen operation unit 204, an appliance registration control unit 205, an icon position acquisition unit 206, a screen information generation unit 207, and a data bus 208.

The communication control unit 201 controls data exchange via the home network. The control unit 202 controls the respective units in accordance with programs. The screen display unit 203 includes display means such as a monitor and displays an image generated by the image information generation unit 207. The screen operation unit 204 includes operation input means such as a mouse and is used when a user inputs information while operating a screen displayed on the screen display unit 203.

The appliance registration control unit 205 performs acquisition control for positional information at the time when a new appliance is connected to the home network. The icon position acquisition unit 206 calculates a position of an appliance icon, which is displayed on the screen display unit 203 and moved by the screen operation unit 204, and acquires the calculated position as an installation position of the appliance. The screen information generation unit 207 generates image information based on floor plan data and the like acquired from the management server 100 via the communication control unit 201 and supplies the image information to the screen display unit 203.

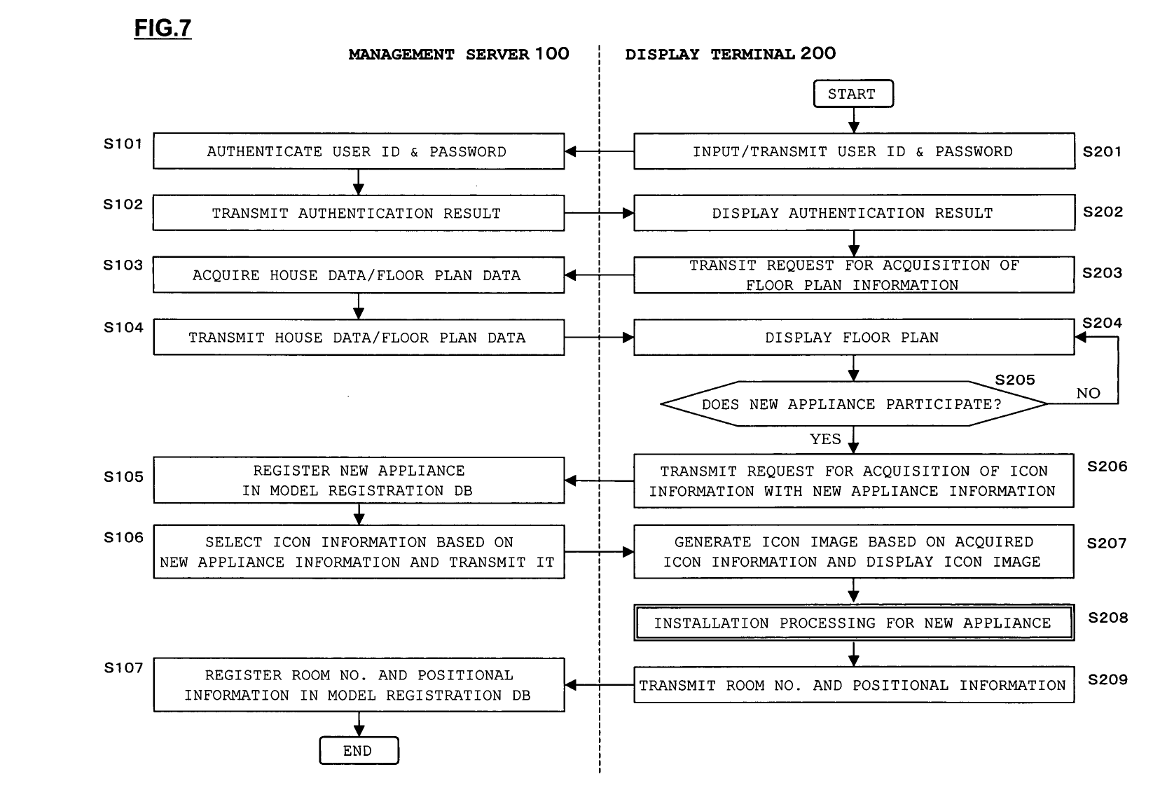

FIG. 7 shows appliance registration processing at the time when a new appliance is connected to the home network.

When a user inputs a user ID and a password in the display terminal 200, the display terminal 200 transmits information on the user ID and the password to the management server 100 (S201). The management server 100 authenticates the received user ID and password (user authentication unit 103) and judges whether the user has an operation authority (S101) . Then, the management server 100 transmits a result of the authentication to the display terminal 200 (S202).

The display terminal 200 displays the received authentication result (indicating whether the user has the operation authority) on the screen display unit 203 (S202) . At this point, if the user does not have the operation authority, the processing is discontinued when the authentication result is displayed. If the user has the operation authority, the appliance registration control unit 205 of the display terminal 200 transmits a request for acquisition of floor plan information to the management server 100 via the communication control unit 201 (S203).

In response to this, the management server 100 reads out floor plan data and house data from the floor plan data storage unit 109, reads out necessary room parts data from the room parts DB 108 (floor plan data registration unit 107), and transmits the floor plan data, the house data, and the room parts data to the display terminal 200 (S103, S104).

The display terminal 200 generates a floor plan image from the received floor plan data, house data, and room parts data (screen information generation unit 207) and displays a floor plan image, for example, as shown in FIG. 5, on a monitor of the screen display unit 203 (S204). Note that FIG. 5 shows a floor plan image of the first floor. When the user clicks “2F”, the screen information generation unit 207 generates a floor plan image of the second floor and displays the floor plan image on the monitor.

Thereafter, the appliance registration control unit 205 of the display terminal 200 judges whether a new appliance is connected to the home network (S205). More specifically, the appliance registration control unit 205 judges whether the appliance registration control unit 205 has newly received a manufacturer code, a model code, a classification code, and a request for participation in the home network via the home network. If it is judged that a new appliance is connected (YES in S205), the appliance registration control unit 205 transmits the received manufacturer code, model code, classification code, and request for acquisition of icon information to the management server 100 via the communication control unit 201 (S206).

In response to this, the management server 100 registers the received manufacturer code, model code and classification code in the model registration DB 106 via the model data registration unit 105 (S105). Then, the management server 100 extracts icon image information of icon information conforming to the received manufacturer code, model code and classification code from the icon-by-model DB 111 (icon selection unit 110) and transmits the icon image information to the display terminal 200 (S106).

The display terminal 200 generates an icon image based on the received icon image information (image information generation unit 207) and superimposes and displays the icon image in a position close to the floor plan image on the monitor (S207). The user can learn a type of the newly connected appliance looking at such a display. Then, the user drags the displayed icon image in an appropriate manner and performs installation processing for the new appliance (S208) . Details of such installation processing will be described in detail later.

When the installation processing for the new appliance ends, the icon position acquisition unit 206 of the display terminal 200 acquires information on an installation position of the new appliance, that is, a room No. and an installation position (location information: X1, Y1, Z1) in the room based on the icon position. Then, the icon position acquisition unit 206 transmits the acquired room No. and the location information (X1, Y1, Z1) to the management server 100 via the communication control unit 201 (S209).

In response to this, the management server 100 registers the positional information (the room No. and the location information) of the appliance in the model registration DB 106 in association with the appliance information registered in S105 (S107). Consequently, the model registration processing concerning the newly connected appliance ends.

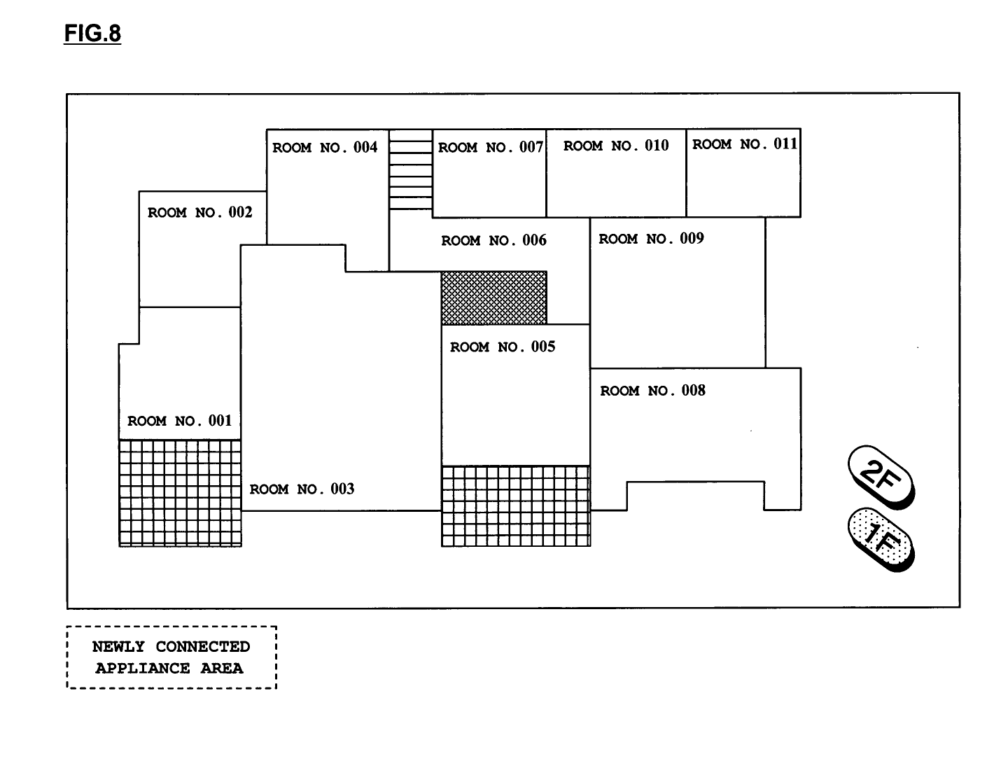

Next, the installation processing for the newly connected appliance in S208 will be explained with reference to FIGS. 8 to 10:

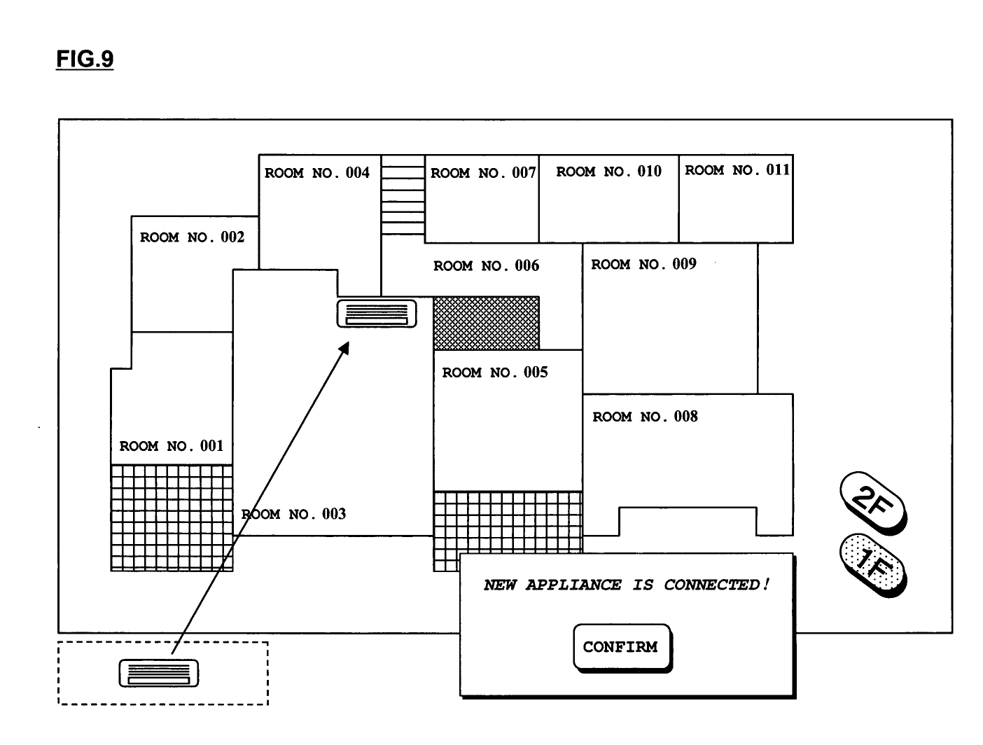

FIG. 8 shows a state in which the floor plan image is displayed in S204. In such a state, when the connection of the newly connected appliance is detected, an appliance icon of the appliance is displayed in a “newly connected appliance area” in the figure. FIG. 9 shows a state at this point. As shown in the figure, a subtitle “new appliance is connected” and a confirmation button are superimposed and displayed on the screen in addition to the appliance icon.

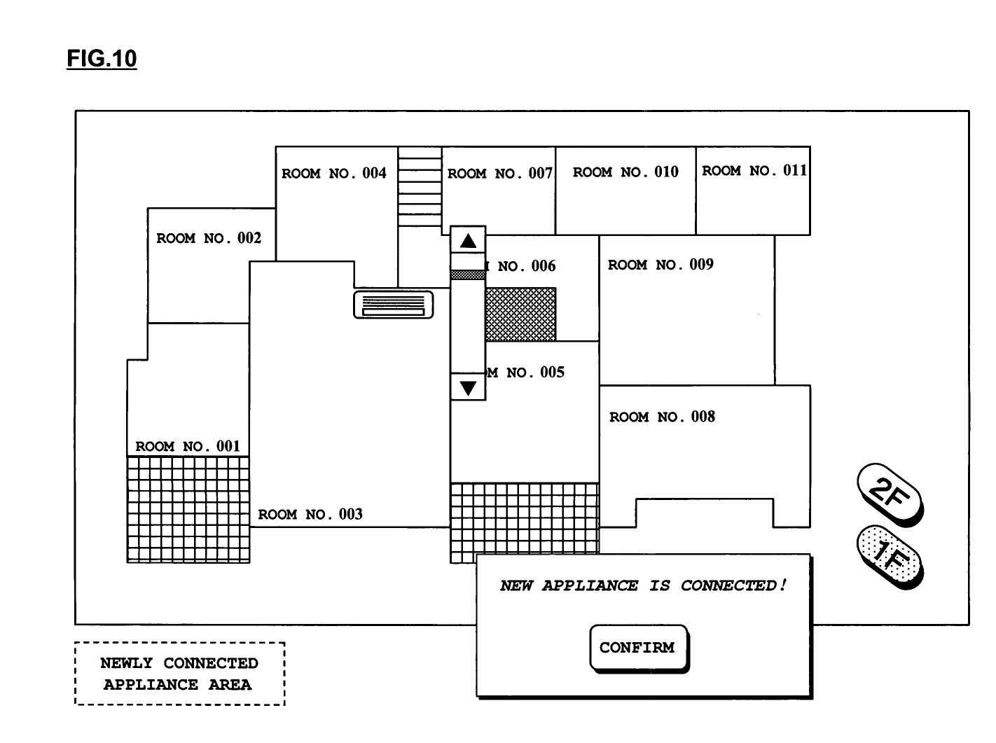

In the state of FIG. 9, the user can operate the screen operation unit 204 to move (drag) the appliance icon to an arbitrary screen position until the user clicks the confirmation button. Then, after moving the appliance icon to a desired position, when the user clicks the confirmation button, a scroll bar for setting a height direction position of the appliance as shown in FIG. 10 is superimposed and displayed on the screen. By changing a position of such a scroll bar, the user can freely set a height position of the appliance from a floor surface. Note that the user can change the position of the scroll bar in an appropriate manner by clicking ▴ or ▾.

After setting the height direction position, when the user clicks the confirmation button, first, the icon position acquisition unit 206 judges in which room the appliance is installed based on boundary information of each room. Then, the icon position acquisition unit 206 acquires X1 and Y1 of the location information (X1, Y1, Z1) in the room as explained above with reference to FIG. 5 and acquires Z1 based on the position of the scroll bar. The icon position acquisition unit 206 transmits the room No. and the location information (X1, Y1, Z1) in the room acquired in this way to the management server 100 in S209 in FIG. 7. Then, the management server 100 registers the room No. and the location information (X1, Y1, Z1) in the model registration DB 106 of the management server 100.

According to this embodiment, it is possible to register positional information of a newly connected appliance in a management server with a simple and intuitive operation of moving (dragging) an appliance icon. Thus, it is possible to avoid complicated registration work and remarkably improve operability at the time of appliance registration.

<Second Embodiment>

In the first embodiment, icon information is held on the management server 100 side. However, in this embodiment, icon information is held in the display terminal 200. Thus, in the management server 100, the icon selection unit 110 and the icon-by-model DB are removed from the structure shown in FIG. 2. In addition, in the display terminal 200, a structure necessary for icon display is added to the structure shown in FIG. 6.

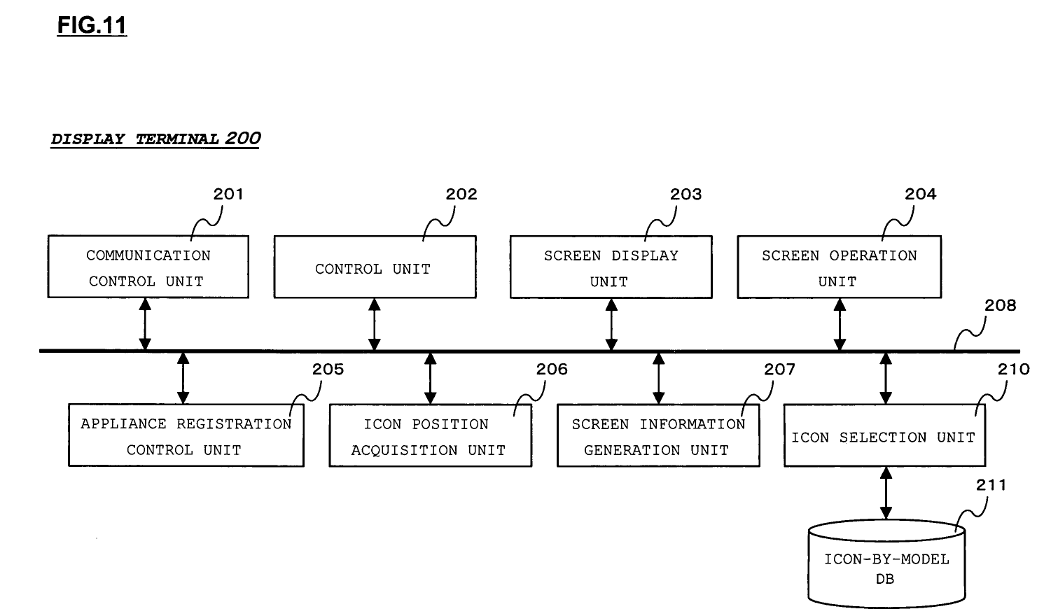

FIG. 11 shows a structure of the display terminal 200 in this embodiment. As shown in the figure, in the display terminal 200 according to this embodiment, an icon selection unit 210 and an icon-by-model DB 211 are added compared with the structure shown in FIG. 6.

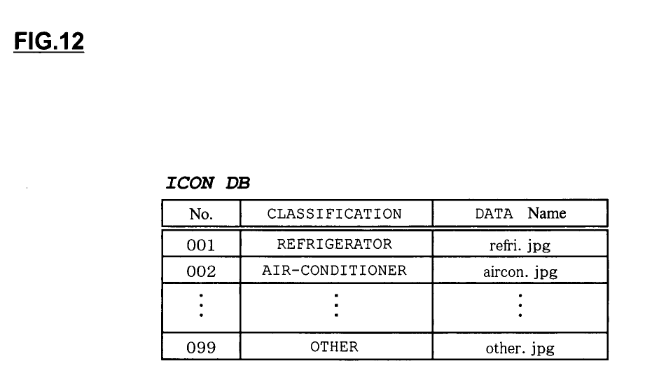

Here, as shown in FIG. 12, table information consisting of a classification of an appliance and a Data Name of icon image information and an icon image information group (contents) corresponding to each Data Name are stored in the icon-by-model DB 211.

The icon selection unit 210 extracts icon image information corresponding to the classification code, among a manufacturer code, a model code and a classification code acquired from a newly connected appliance, from the icon-by-model DB 211 and sends the icon image information to the image information generation unit 207. The screen information generation unit 207 generates an appliance icon from the received icon image information and superimposes and displays the appliance icon on a floor plan image on the screen display unit 203. Thereafter, the installation processing (S208) for the new appliance is performed according to the same procedures as explained with reference to FIGS. 8 to 10, and location information of the newly connected appliance is acquired.

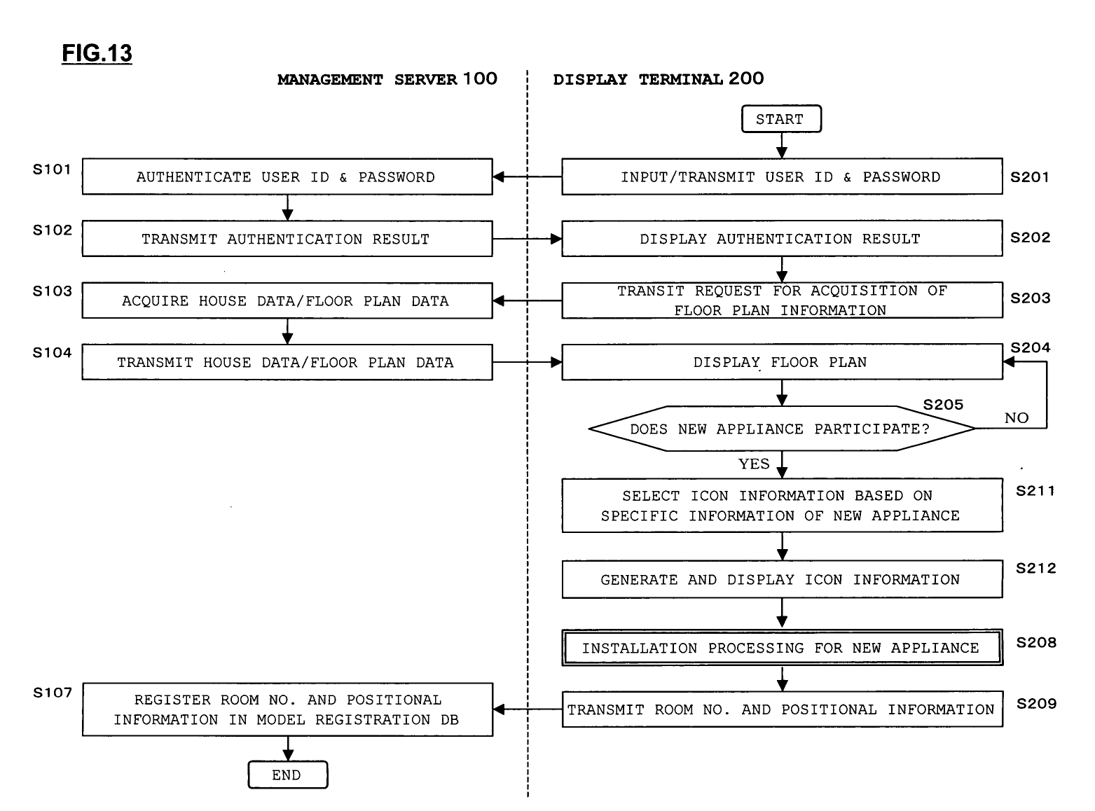

Note that appliance registration processing at the time when the new appliance is connected to the home network is change from FIG. 7 to FIG. 13. In other words, in a processing flow in FIG. 13, the processing in S206→S105→S106→S207 in FIG. 7 is changed to S211→S212. In short, instead of receiving transmission of icon information from the management server 100, as described above, the screen information generation unit 207 extracts icon image information corresponding to the classification code acquired from the newly connected appliance from the icon-by-model DB 211 (S211), generates an appliance icon from this icon image information, and superimposes and displays the appliance icon on a floor plan image (S212).

According to this embodiment, since icon information is extracted on the display terminal 200 side, it is unnecessary to request the management server 100 to transmit icon information. Thus, it is possible to simplify processing at the time of installation position registration compared with the first embodiment. However, in the case in which data stored in the icon-by-model DB 211 is as shown in FIG. 12, icon display closely corresponding to a manufacturer and a model cannot be performed. Thus, intuitiveness at the time of connected appliance confirmation is slightly inferior to the first embodiment.

<Third Embodiment>

In the first and the second embodiments, an installation position of an appliance is set according to a room and a position in the room (location information: X1, Y1, Z1). However, in this embodiment, an installation position of an appliance is set according to only a room.

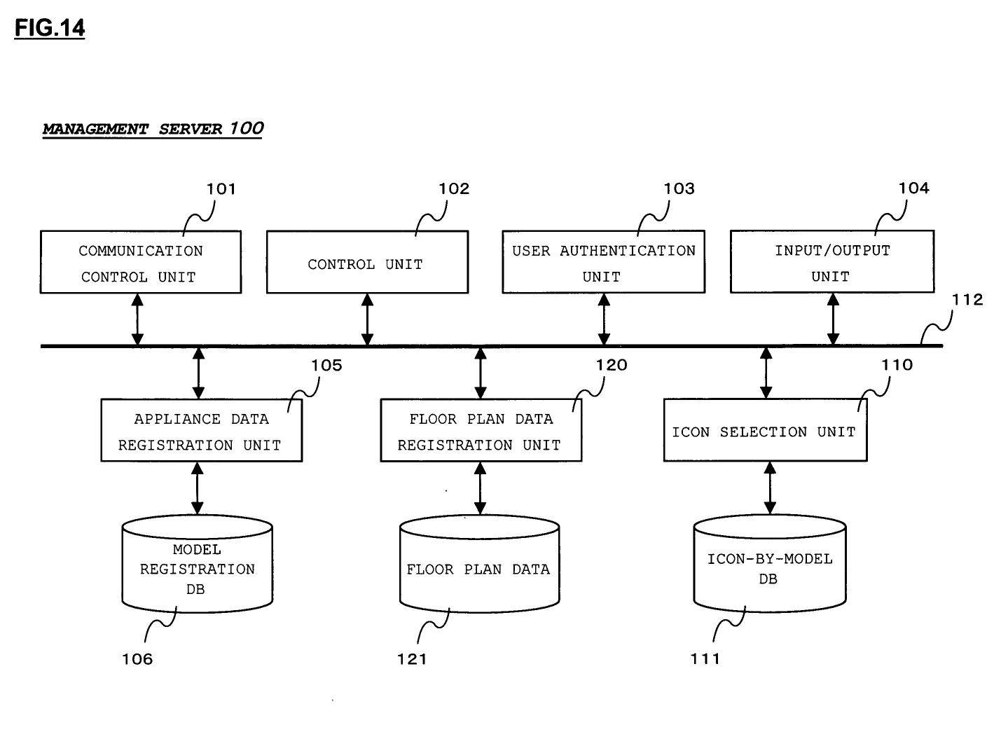

FIG. 14 shows a structure of the management server 100 in this embodiment. In this embodiment, compared with the first and the second embodiments, contents of data registered in the model registration DB 106 are changed. In addition, the room parts DB 108 is removed, and floor plan data different from those in the first and the second embodiment is stored in a floor plan data storage unit 121.

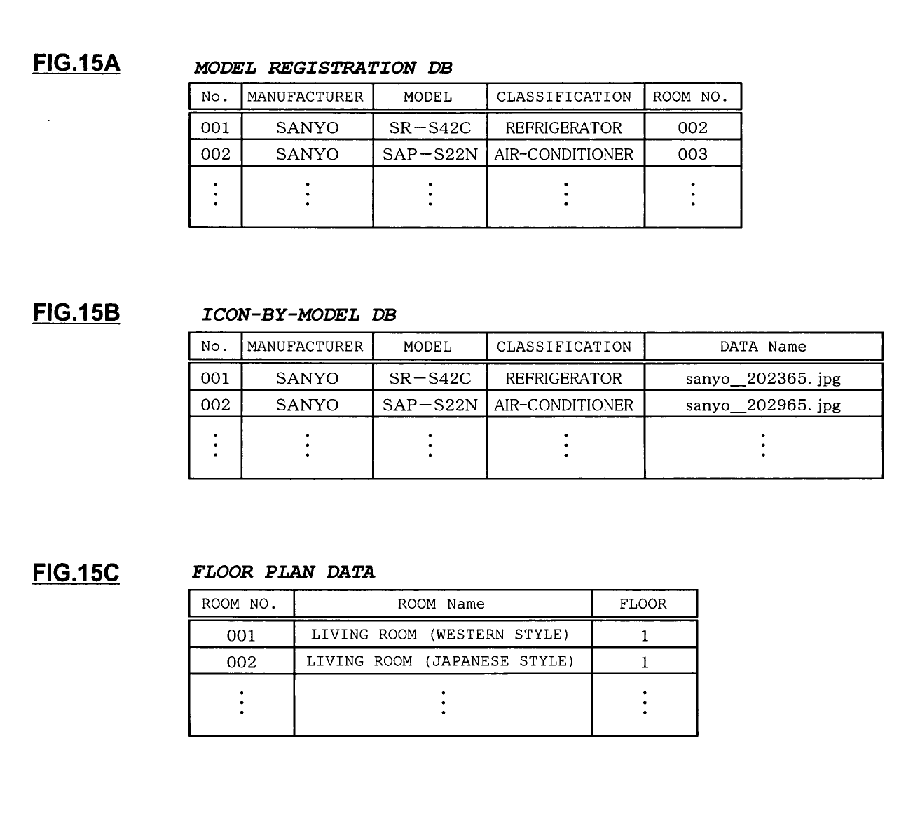

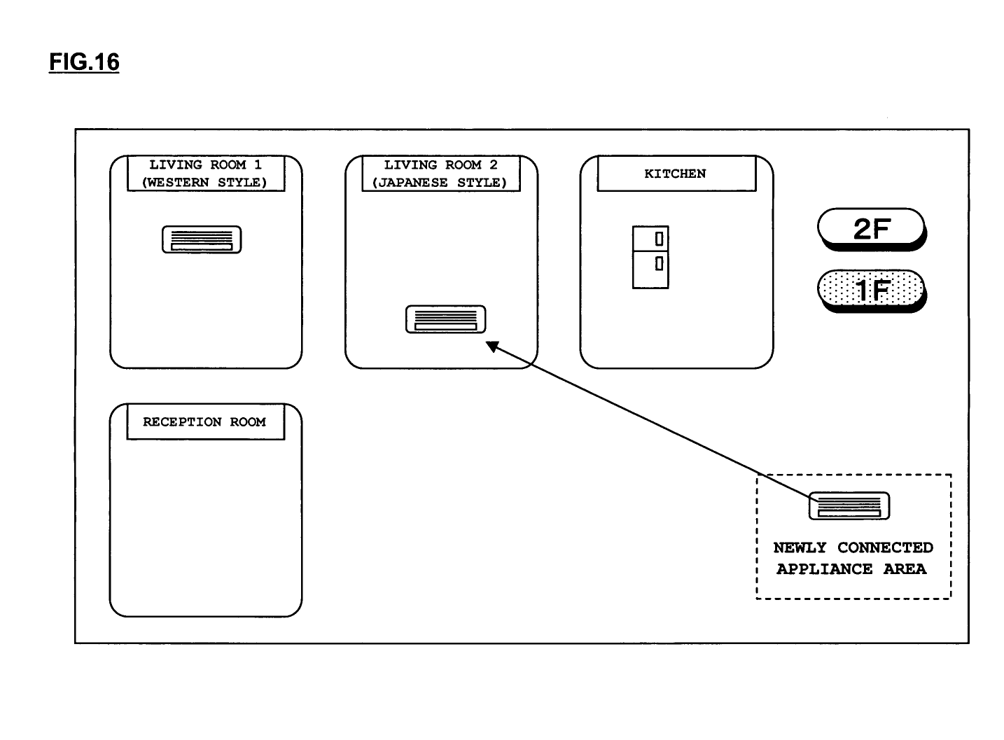

In this embodiment, as shown in FIG. 15A, only a room No. is registered in the model registration DB 106 as information on an installation position of an apparatus. In addition, as shown in FIG. 15C, a room No., a room name, and a floor are stored in the floor plan data storage unit 121. At the time of registration of a newly connected appliance, for example, as shown in FIG. 16, only rooms constituting a floor plan of each floor are displayed, and a shape, an arrangement, and the like of each room is not displayed.

When a new appliance is connected to the home network, icon image information is acquired as in the first or the second embodiment, and a corresponding appliance icon is displayed in a newly connected appliance area. When a user moves (drags) an appliance icon to a corresponding room, a room No. of a moving destination room is acquired as information on an installation position. Then, this room No. is transmitted to the management server 100 from the display terminal 200 as positional information and registered in the model registration DB 106 in the management server 100.

According to this embodiment, since only a room No. is registered as installation position information of an appliance, it is possible to simplify contents of data stored in each DB and also simplify display processing. However, since positional information is only the room No., there is also an inconvenience that fine control corresponding to a position in a room cannot be performed.

The embodiments (first, second, and third embodiments) according to the present invention have been explained. However, it is needless to mention that the present invention is not limited to such embodiments and various alterations are possible.

For example, in the embodiments, as shown in FIG. 10, it is possible to set a height of an appliance by superimposing and displaying a scroll bar on a screen. However, a height direction may be set by other methods. For example, it is also possible to display the room three-dimensionally and set a position in a height direction by moving an appliance icon in this display. In this case, it is necessary to change the room parts data to three-dimensional image information such that the three-dimensional display can be performed.

In the embodiments, icon information is held by the management server 100 or the display terminal 200. However, the icon information maybe held by an appliance itself. In this case, the icon selection unit 110 and the icon-by-model DB 111 in the embodiments can be removed. In connecting an appliance a new, it is sufficient to acquire the icon information from the appliance and display the icon information on a screen.

In the embodiments, the judgment on whether a new appliance is connected to the home network (FIG. 7: S205) is performed on the display terminal 200 side and, when it is judged that an appliance is connected anew, a request for transmission of icon information attached with appliance information of the newly connected appliance is transmitted to the management server 100 from the display terminal 200 (FIG. 7: S206). However, these kinds of processing may be performed on the management server 100 side.

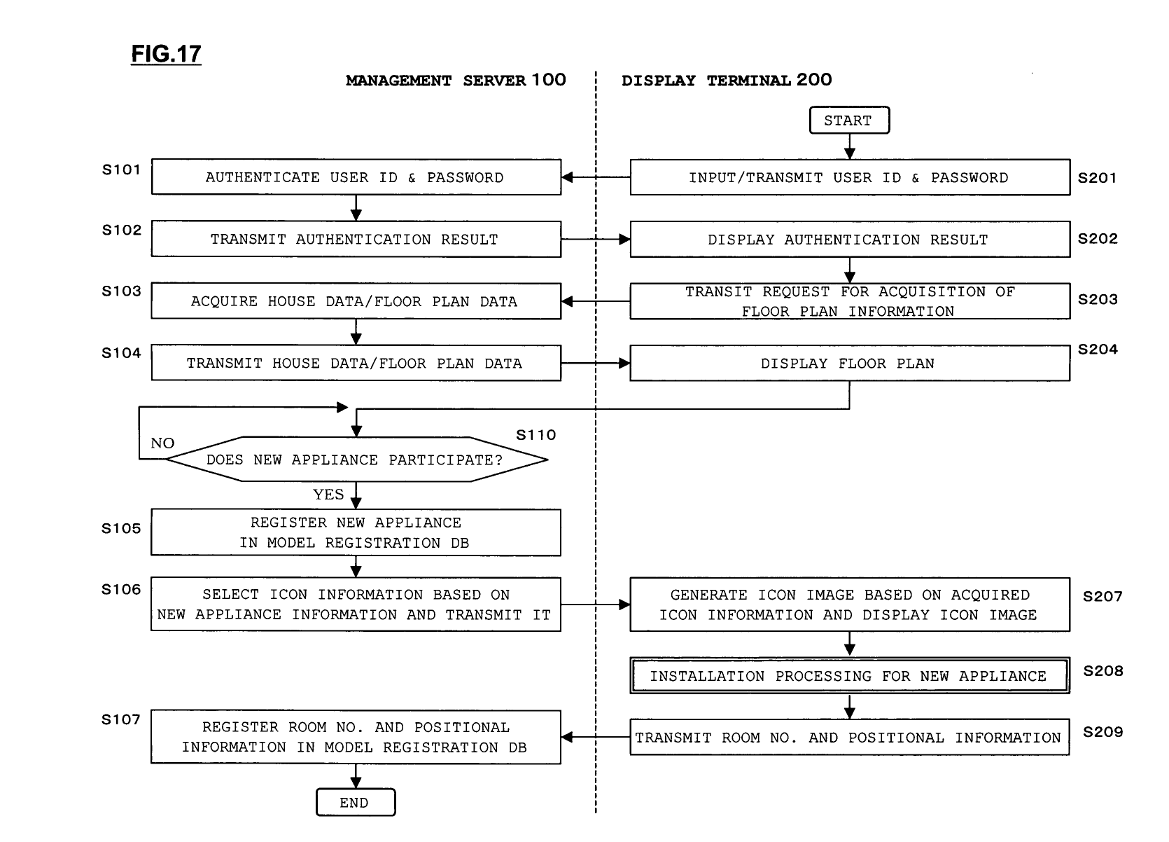

In other words, as shown in FIG. 17, the management server 100 judges whether a new appliance is connected to the home network (S110) and, when it is judged that a new appliance is connected to the home network, registers appliance information of the appliance in the model registration DB 106 (S105) and extracts icon information corresponding to the appliance from the icon-by-model DB 111 and transmits the icon information to the display terminal 200 (S106). Consequently, it is unnecessary to transmit a request for acquisition of an icon from the display terminal 200 to the management server 100, and it is possible to realize simplification of processing.

In the embodiments, the location information (X1, Y1, Z1) is obtained on the display terminal 200 side. However, it is also possible that only coordinate data of an installation position of an icon and positional data of a scroll bar are acquired on the display terminal 200 side and transmitted to the management server 100, and location information is obtained on the management server 100 side based on these data.

Note that, in the embodiments, when an icon is displayed on a floor plan image, it is preferable to perform display control so as not to place the icon on a boundary line of each room. For example, in dragging the icon from a room A to the next room B, when a reference point (a reference point for acquiring a position) of the icon is in the room A, the icon is displayed so as to be near a wall on the room A side and entirely included in the room A, and at timing when the reference point of the icon moves to the room B, the icon is displayed so as to be near a wall on the room B side and entirely included in the room B.

When an appliance is installed near a wall, it is advisable to rotate and display the icon in an appropriate manner such that the rear surface of the appliance is in contact with the wall. For example, orientation information is added to icon information, and this orientation information and boundary information of room parts are compared, and display is adjusted such that an orientation of the icon is perpendicular to the wall. Consequently, it is possible to perform operations at the time of movement of the icon and installation of the appliance more smoothly.

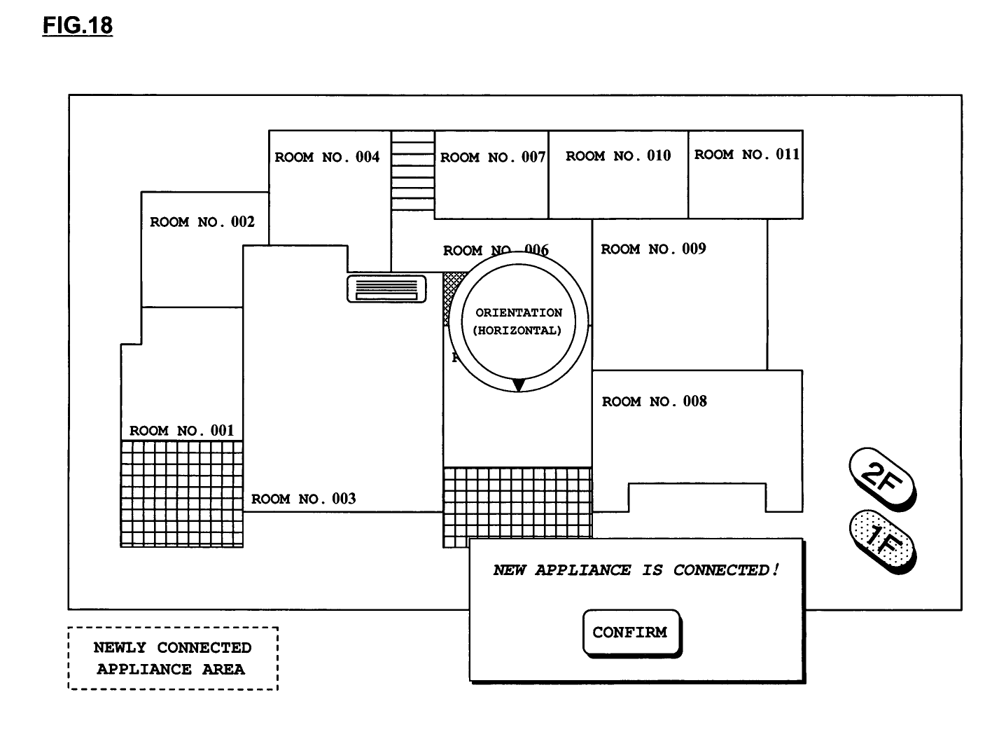

In the embodiments, location information is constituted according to in which room an appliance is installed or in which position of which room the appliance is installed. However, an orientation of the appliance in an installed state may be added to the location information. For example, in the case in which display control is performed such that an orientation of an icon is perpendicular to a wall as described above, such orientation information only has to be detected from an amount of rotation of the icon at the time of the display control. Alternatively, as shown in FIG. 18, it is also possible that an indication for setting an orientation of an appliance (▾ is dragged and dropped to set an orientation) is superimposed and displayed on a screen such that a user can set an orientation of an appliance in an appropriate manner. Note that an orientation of an appliance in the horizontal direction is set in FIG. 18. However, if a similar indication is superimposed and displayed separately for setting of an orientation in the vertical direction, an orientation in the vertical direction can also be set.

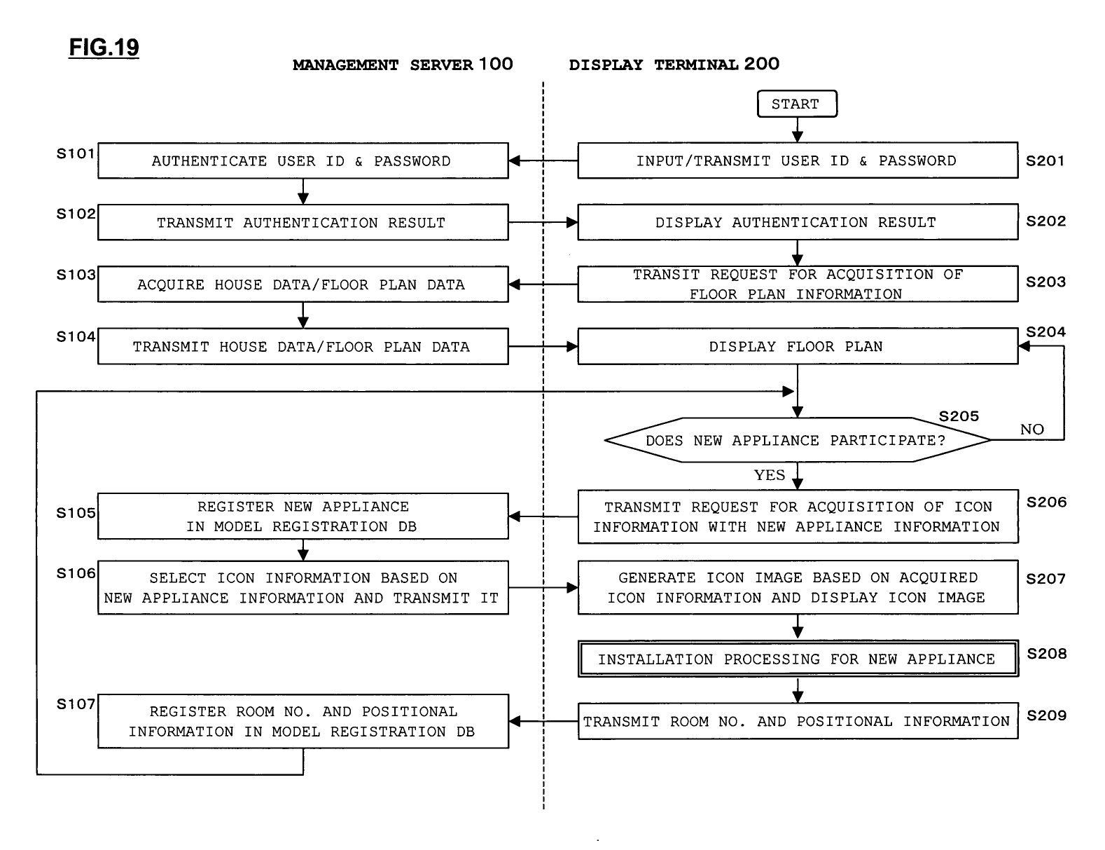

Note that, although the position setting processing for one appliance is shown in the processing flow of FIG. 7, it is more practical to adopt a flow shown in FIG. 19 as a processing flow of the system. Here, in respective processing steps (S101, S102, . . . , S107, and S201, S202, . . . , S209) shown in FIG. 19, the same processing as the respective processing steps (S101, S102, . . . , S107 and S201, S202, . . . , S209) of the processing flow shown in FIG. 7 is performed. In the processing flow in FIG. 19, when position setting processing for a new appliance ends, the processing returns to S205, and it is judged whether an appliance is connected to the home network anew. Then, the floor plan display and the connection judgment for a new appliance are continued (S204, S205) until an appliance is connected anew. In response to judgment that an appliance is connected anew (YES in S205), positional information setting processing in S206 and subsequent steps is executed.

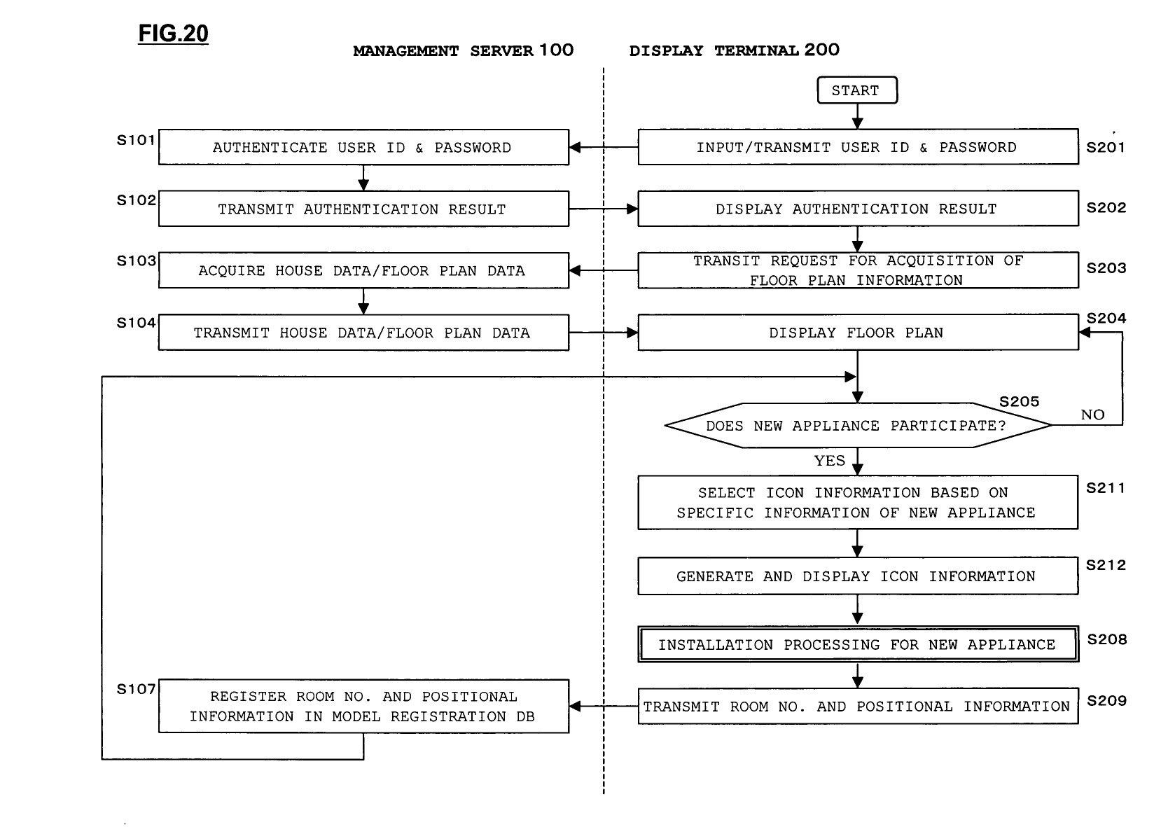

Similarly, it is more practical to change the processing flow in FIG. 13 in the embodiment mode to a flow shown in FIG. 20. Here, the same processing as the respective processing steps (S101, S102, S103, S104, S107 and S201, S202, . . . , S205, S211, S212, S208, S209) of the processing flow shown in FIG. 13 is performed in respective processing steps (S101, S102, S103, S104, S107 and S201, S202, . . . , S205, S211, S212, S208, S209) shown in FIG. 20. In other words, in the processing flow in FIG. 20, when position setting processing for a new appliance ends, the processing returns to S205, and it is judged whether an appliance is connected to the home network anew. Then, the floor plan display and the connection judgment for a new appliance are continued (S204, S205) until an appliance is connected anew. In response to judgment that an appliance is connected anew (YES in S205), positional information setting processing in S206 and subsequent steps is executed.

In addition, in the embodiments, the management server 100 and the display terminal 200 are provided separately. However, the functions of the display terminal 200 may be given to the management server 100.

Moreover, in the embodiments, it is assumed that the management server 100 is installed in a house. However, the management server 100 may be installed outside the house and connected to a display terminal in the house via a public network such as the Internet. In this case, the management server 100 manages the model registration data, the house data, and the floor plan data for each user (each house) and reads out and provides data of the user to a user side terminal in response to a request from a display terminal on a user side.

Other various alterations are possible for the embodiments of the present invention within the scope of the technical idea indicated in the patent claims.

1. A network apparatus that is connected to a home network, comprising:
room image display means that displays a room constitution in a building as a room image;
appliance icon display means that generates an icon image corresponding to an appliance connected to the home network and superimposes and displays the icon image on the room image;
appliance icon moving means that moves the appliance icon on a display screen; and
position detection means that detects an installation position of the appliance in the building based on a position of the appliance icon after the movement.

2. A network apparatus according to claim 1, wherein the room image display means includes means that divides a floor plan image, in which rooms in the building are arranged as a floor plan, for each floor of the building and displays the floor plan image.

3. A network apparatus according to claim 1, wherein the appliance icon display means includes means that acquires corresponding icon image information based on appliance information acquired from an appliance connected to the home network.

4. A network apparatus according to claim 3, wherein the appliance icon display means includes means that is provided with an appliance icon database storing icon image information in association with a predetermined appliance section and extracts icon image information, which corresponds to the appliance information acquired from the appliance connected to the home network, from the appliance icon database.

5. A network apparatus according to claim 3, wherein the appliance icon display means includes means that provides the appliance information acquired from the appliance connected to the home network to a server provided with an appliance icon database storing icon image information in association with a predetermined appliance section and requests the server to transmit corresponding icon image information.

6. A network apparatus according to claim 1, wherein the position detection means includes means that detects a room to which the appliance icon moves and a position of the appliance icon in the room and acquires identification information of the room and information on the position of the appliance icon in the room as installation position information of the appliance.

7. A program product that gives a computer a function for acquiring information on an installation position of an appliance connected to a home network, comprising:
room image display processing for displaying a room constitution in a building as a room image;
appliance icon display processing for generating an icon image corresponding to the appliance connected to the home network and superimposing and displaying the icon image on the room image;
appliance icon moving processing for moving the appliance icon on a display screen; and
position detection processing for detecting an installation position of the appliance in the building based on a position of the appliance icon after the movement.

8. A program product according to claim 7, wherein the room image display processing includes processing for dividing a floor plan image, in which rooms in the building are arranged as a floor plan, for each floor of the building and displaying the image.

9. A program product according to claim 7, wherein the appliance icon display processing includes processing for acquiring corresponding icon image information based on appliance information acquired from the appliance connected to the home network.

10. A program product according to claim 9, wherein an appliance icon database storing icon image information in association with a predetermined appliance section is further provided, and the appliance icon display processing includes processing for extracting icon image information, which corresponds to the appliance information acquired from the appliance connected to the home network, from the appliance icon database.

11. A program product according to claim 9, wherein the appliance icon display processing includes processing for providing the appliance information acquired from the appliance connected to the home network to a server provided with an appliance icon database in which icon image information is stored in association with a predetermined appliance section and requesting the server to send corresponding icon image information.

12. A program product according to claim 7, wherein the position detection processing includes processing for detecting a room to which the appliance icon is moved and a position of the appliance icon in the room and acquiring identification information of the room and information on an appliance icon position in the room as installation position information of the appliance.
